(19) United States
(12) Patent Application Publication
(10) Pub. No.: US 2007/0199481 A1
(43) Pub. Date: Aug. 30, 2007

(54) Synthetic Organoclay Materials

(75) Inventor: Jules Caspar Albert Anton Roelofs, Ultrecht (NL)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: Engelhard Corporation, Iselin, NJ (US)

(21) Appl. No.: 10/572,268

(22) PCT Filed: Sep. 14, 2004
(86) PCT No.: PCT/NL04/00636

§ 371 Date: Jan. 3, 2007

(30) Foreign Application Priority Data
Sep. 15, 2003 (EP) 03077916.9

(51) Int. Cl. C04B 14/04; C08K 9/04

(52) U.S. Cl. 106/487; 977/779; 977/783; 977/811; 524/445; 523/216

(57) ABSTRACT

The present invention is directed to synthetic cationic organo-stevensite clay material, in the use thereof in nanocomposites and to the production thereof.

### BACKGROUND OF THE INVENTION

The present invention is directed to synthetic organoclay materials that, are based on a clay and an organic compound, to a process for producing them and to the use thereof in various applications. The materials can be added to a wide variety of polymer, plastic and resin matrices to form inventive nanocomposite materials of enhanced structural strength. They can also be used as rheological additives, as flame retardant additive, or in water purification applications.

### Synthetic Clay Materials

Clay minerals are solid substances, substantially made up of metal and oxygen atoms, whose crystal lattice has a layered structure. This layered structure consists of three repeating layers, Located centrally in this elementary three-layer structure is a layer of substantially trivalent or substantially divalent metal ions (cations). Examples of clay minerals with substantially trivalent ions are montmorillonite and beidellite; examples of clay minerals with substantially divalent ions are hectorite and saponite. The metal ions present in the central layer are octahedrally surrounded by oxygen and hydroxyl ions. In a clay mineral with trivalent ions, two of the three octahedron positions are occupied by metal ions. Accordingly, this is referred to as a di-octahedral clay mineral. In a clay mineral with divalent metal ions, all three octahedron positions are occupied by metal ions; this is referred to as a tri-octahedral clay mineral. On opposite sides of this layer of octahedrally surrounded metal ions occurs a layers of tetrahedrally surrounded ions. These tetrahedrally surrounded ions are generally silicon ions, while a part of the silicon can optionally be replaced by germanium, aluminum, boron and the like.

The unit of the tetrahedrally surrounded silicon ions is Si₈O₂₀ (OH)₄. In this connection it is noted that in the tetrahedron and octahedron layers the actual point where the charge is located cannot always be indicated equally clearly. The term ‘ions’ as used in this context accordingly relates to the situation where an atom, given a completely ionic structure, should possess an electrostatic charge corresponding with the oxidation state.

Essential to clay minerals is that a part of the cations present are substituted by ions of a lower valency or a vacancy, i.e. absence of a cation. Thus it is possible to substitute a part of the trivalent or divalent metal ions in the octahedron layer by divalent and monovalent metal ions, respectively, or to generate vacancies during manufacturing.

With substantially trivalent metal ions, this substitution results in montmorillonite and with substantially divalent metal ions in hectorite. In case the material comprises divalent metal ions in the octahedral layer with vacancies, the clay is a stevensite.

It is also possible to substitute the tetravalent silicon ions in the tetrahedron layers by trivalent aluminum, germanium or boron ions. With a clay mineral with almost exclusively trivalent ions in the octahedron layer, the result is then a beidellite and with a clay mineral having almost exclusively divalent ions in the octahedron layer, the result is a saponite.

Of course, substitution by an ion of lower valency or deletion of an ion leads to a deficiency of positive charge of the platelets. This deficiency of positive charge is compensated by including cations between the platelets. Generally, these cations are included in hydrated form, which leads to the swelling of the clay. The distances between the three-layer platelets is increased by the inclusion of the hydrated cations. This capacity to swell by incorporating hydrated cations is characteristic of clay minerals.

The swelling clay minerals having a negative charge of from 0.4 to 1.2 per unit cell, are known as smectites. The cations in the interlayer of swollen clay minerals are strongly hydrated. As a result these ions are mobile and can be readily exchanged.

One of the major problems in the use of natural clay minerals is that although these materials may be very cheap, the properties are very difficult to control. The synthesis of clay minerals according to the current state of the art is technically difficult. Customarily, a protracted (a few weeks) hydrothermal treatment is used at relatively high temperatures and pressures, under agitation of the aqueous suspension In general, only a few grams or even only some tens of milligrams of a clay mineral can be synthesized simultaneously. The application of this technology on a large (industrial) scale is very difficult, if not impossible. As a result, synthetic clay minerals are costly.

Owing to the poorly controllable properties of natural clay minerals and the high price of synthetic clay minerals, the use of clay minerals for catalytic purpose has remained quite limited. Although the patent literature around 1980 evidenced much research effort in the field of the catalysis of (pillared) clay minerals, the technical application thereof has remained very slight.

In WO-A96-07613 a process has been described for producing synthetic swelling clay minerals.

Organoclay Materials

Organically modified clays, also called organoclays, have been used for many years as rheological additives for solvent based systems. They are usually produced by making a water dispersion of a naturally occurring phyllosilicate clay, usually a smectite clay, and adding to it a quaternary ammonium salt of a long chain fatty acid to produce an organically modified clay by cation exchange reaction and adsorption.

The reaction may cause the organoclay to coagulate from the water dispersion which allows for its isolation by filtration and washing. Similarly, organoclays can be made without water by extrusion mixing, with heat and shear, smectite clay and the quaternary ammonium compound or compounds with no water or other solvent being present. This process usually produces an organoclay of lower quality however, since, among other reasons, the final product still has salt reaction byproducts that cannot be washed or readily isolated from the organoclay and for other reasons.

The clays are typically smectite clays which are layered phyllosilicates. Smectite clays possess some structural characteristics similar to the more well-known minerals talc and mica. Their crystal structures consist of two-dimensional layers formed by fusing two silica tetrahedral sheets to an edge-shared dioctahedral or trioctahedral sheet of either alumina (for example montmorilonite) or magnesia (for example bectorite)—each of the different smectite clays having somewhat different structures.

Polymers, resins and plastics containing clay additives have recently become widely used as replacements for heavier steel and other metal products, especially in the field of automotive manufacturing. They have also found use in a growing number of other areas including as bridge components and as replacements for heavier steel parts in ship construction. Using extrusion and injection molding, a nylon matrix, for example, has been successfully reinforced with smectite-type clays (and organoclays based on the smectite clays, bentonite and hectorite) dispersed therein to form molecular composites of nylon and finely dispersed silicate clay platelet layers. Such products, often called nanocomposites, have enhanced structural, tensile, impact and flexural strength.

The behavior of the resultant plastic/clay product (or nanocomposite) is qualitatively different from that exhibited by the plastic, polymer or resin alone and has been attributed by some workers in the field to the confinement of the matrix chains between the clay's millions of microscopic layers. It has long been known that bentonite and hectorite are clays which are composed of flat silicate platelets of a thickness no more than about one nanometer.

Organoclay materials have been used extensively as plastics additives as reological and/or flame retardant additives, or in water purification.

Early work using organoclays in the preparation of nanocomposites is reflected in U.S. Pat. No. 2,531,896. This patent filed in 1947 teaches the use of organically modified bentonites to provide structural reinforcement to elastomer, such as rubber, polychloroprene and polyvinyl compounds. Over a generation later, additional patents begin to appear. A number of patents obtained by Toyota starting in 1984: U.S. Pat. Nos. 4,472,538; 4,739,007; 4,810,734; 4,889,885; and 5,091,462 use organoclay additives for plastics and describe plastic structures commercially used, for example, to replace steel components in automobiles.

Organoclay compositions useful as rheological additives which comprise the reaction product of smectite clay, quaternary ammonium compounds and organic anions wherein a quaternary-organic anion complex is intercalated with the smectite clay—have for example been described in U.S. Pat No. 4,412,018. As organic anions a large variety of organic compounds are described, including carboxylic acids, capable of reacting with the quaternary used.

Manufacture to date of nanocomposite materials has often involved mixing an organoclay with a polymer powder, pressing the mixture into a pellet, and heating at the appropriate temperature. For example, polystyrene has been intercalated by mixing polystyrene with an alkylammonium montmorillonite and heating in vacuum. Temperature of heating chosen to be above the bulk glass transition temperature of polystyrene ensuring polymer melt.

U.S. Pat. Nos. 5,514,734 and 5,385,776—are in general directed toward a nylon 6 matrix and clays using non-standard organic modification. See also in this regard Vaia et al., the article entitled Synthesis and Properties of Two-Dimensional Nano Structures By Direct Intercalation of Polymer Melts in Layered Silicates, Chemistry of Materials 1993, 5, pages 1694-1696.

General Electric Company U.S. Pat. No. 5,530,052 describes silicate materials, including montmorillonite clays, modified with at least one heteroaromatic cation and used as additives to specified polymers to make nanocomposites.

Other prior art shows making polymer-clay intercalates directly by reaction of the monomers in the presence of clays. See Interfacial Effects On The Reinforcement Properties Of Polymer Organoclay Nanocomposites, H. Shi, T Lan, T. H. Pinnavaia, Chemistry of Materials, 1996, pages 88 et seq.

However, these materials are all based on naturally occurring clay minerals with the inherent disadvantage of fluctuation in purity and composition.

The synthesis of organo-hectorite clay materials has been described in K. A. Corrado et al, A study of organo-hectorite clay crystallization, Clay Minerals (1997) 32, 29-40. Some other publications mention the multi step synthesis of organo-hectorite or organo-montmorrillonite by first synthesizing the clay, followed by exchange of metal ions with cationic organic compounds.

### SUMMARY OF THE INVENTION

It is an object of the invention to provide novel organoclay materials that are suitable for use in nanocomposites and other applications.

In a fast embodiment the invention is directed to synthetic cationic organo-stevensite clay material.

In a further embodiment the organoclay materials comprise an elementary swelling stevensite clay-structure of three repeating layers, with centrally in this elementary three-layer structure a layer of substantially divalent metal cations, octahedrally surrounded by oxygen and/or hydroxyl ions, and on both sides of said octahedrally surrounded layer, layers of tetrahedrally surrounded tetravalent cations, wherein at least part of the cation sites in the octahedrally surrounded layer have not been occupied, thereby creating vacancies, and wherein the said elementary three-layer structure further contains one or more organic cations, generally located between the layers or on the basal surface of the three layer structure.

The clay materials are made up of elementary three-layer platelets consisting of a central layer of octahedrally oxygen-surrounded metal ions (octahedron layer), which layer is surrounded by two tetrahedrally surrounded, tetravalent ions, such as silicon-containing layers (tetrahedron layers), and a number of such elementary platelets being optionally stacked. The dimensions of the clay platelets generally vary from 0.01 μm to 1 μm, the number of the stacked elementary three-layer platelets varies from one platelet to on average twenty platelets, while in the octahedron layer preferably at most 30 at. % of the metal ions has been replaced by a vacancy. Consequently these layers having a deficiency of positive charge because of the vacancies.

This deficiency of positive charge is compensated by protons and/or cation, including organic cations which are present between the platelets.

As divalent ions, magnesium, zinc nickel, cobalt(II), iron(II), manganese(II), and/or beryllium are preferable present in the octahedron layer. In The tetrahedron layer, silicon and/or germanium is present as tetravalent component. A part of the hydroxyl groups present in the platelets can partly be replace by fluorine.

In the invention the synthetic organoclay material is a steven site, with Zn, Mg, Co, Ni, or combinations thereof in the octahedral layer. Stevensite N_{x/z}^{z+}[M²⁺_{6-x•x}][Si₈]O₂₀(OH)₄.nH₂O belongs to the class of triochtahedral smectites and consists of octahedrally coordinated divalent metal ions with vacancies, covered on both sides with a tetrahedral sheet of SiO₄ tetrahedra. Interlayer cations are present for charge compensation.

The advantages of these materials reside among others in the better dispersibility, presumably due to the relatively low charge density, and a much easier synthesis.

The preparation of the synthetic stevensite clay minerals according to the invention is surprisingly simple. In the widest sense, the components required for the synthesis, oxides of silicon (germanium) for the tetrahedron layer and the divalent ions for the octahedron layer, are presented in aqueous medium, optionally in combination with the cationic organic compound, are brought to the desired pH. An initial pH of between 0.5 and 2.5 is preferred. Above this range the preparation of the stevensites results in less optimal products. The materials are maintained for some time at a temperature of 60-350° C., with the pH being maintained within the desired range. The reaction time strongly depends on temperature, and hence on pressure, with higher temperatures enabling shorter reaction times. In practice, reaction time to the order of 1-72 hours are found at the lower temperatures, 60-125° C., whereas at temperatures in the range of 150° C. and higher, reaction times to the order of some minutes to approximately 2.5 hours may suffice. Preparation of magnesium based materials require a longer reaction time than materials based on zinc.

Such a process can be carried out in a number of manners, depending on the nature of the components and the desired result.

In accordance with a first variant, the starting products for the preparation are mixed as a solution, including the cationic organic material, and the pH is adjusted to the range where the preparation is to take place. It is also possible to add the cationic organic compound at a later stage of the preparation.

During the following heating operation, the pH is kept substantially constant, for instance through hydrolysis of urea, injection of a neutralizing agent below the surface of the well-stirred liquid, or with electrochemical means.

However, for achieving a rapid and proper preparation, it is preferred to homogeneously increase the pH of a solution of the metal ions to be incorporated into the octahedron layer in the presence of silicon dioxide. It is preferred to use water glass as the source of silicon dioxide. The source of the other metal ions is not very critical. This choice is mainly governed by aspects of costs and the specific anions, some of which are less easy to wash out of the final product, or may interfere with the specific application of the material.

In the presence of two different metal ions, these metal ions are incorporated into the octahedron layer side by side. The typical swelling clay structure is brought about by the presence of divalent and vacancies side by side in the octahedron layer. The temperature at which the pH is homogeneously increased influences the dimensions of the clay platelets formed. At higher temperatures, larger clay platelets are formed. Also the choice of the metal in the octahedral layer influences the size of the platelets. For examples, the use of magnesium results in smaller sizes (length, thickness) of the plates than when zinc is used. By using a combination of these metals, the size of the plates can be controlled easily. However, it is to be noted that in a one-step synthesis, both zinc and magnesium result in comparable products with large platelet size.

The stacking of the elementary clay platelets, i.e. the number of elementary three-layer systems, is determined by the ionic strength of the solution form which the precipitation takes place. At a higher ionic strength, which can be achieved through the addition of, for instance, sodium nitrate, the elementary clay platelets is therefore controlled by setting the ionic strength of the solution wherein the reaction resulting in the clay minerals is carried out.

The dimension of the elementary platelets of clay minerals having substantially zinc ions in the octahedron layer is approximately 0.05-0.2 μm, whereas the corresponding dimension in the case of substantially magnesium ions in the octahedron layer is 0.01 to 0.03 μm.

The cationic organic material is present in the starting solution in such an amount that the final material contains between 5 and 35 wt. % of said material. The amount of organic material is mainly determined by the charge deficiency in the octahedral layer and the molecular weight of the cationic organic material.

Suitable cationic organic materials are the various protonated alkyl-aryl-, aralkyl- and alkarylamines (primary and secondary), alkylaryl-, aralkyl- and alkaryl-phosphonium compounds and alkylaryl-, aralkyl- and alkaryl-sulphonium compounds. These compounds can optionally be substituted. The nature of the organic moiety determines the hydrophobic/hydrophilic balance of the final material, heavier moieties leading to more hydrophobic properties. It is to be noted that the alkyl-aryl-, aralkyl- and alkaryl moieties, optionally may be substituted.

In a preferred embodiment the process is used for producing zinc or magnesium stevensites (as described above), in which process the pH is adjusted during production by the homogeneous decomposition of urea in the solution. The cationic organic material is preferably octadecyl amines, used in protonated form.

After the preparation is finished, the product is separated form the aqueous phase, optionally after washing and drying.

With respect to the incorporation of the cationic organic material in the clay, various possibilities exist. In a preferred embodiment, the organic material is present already in the starting solution. For stevensites this has the surprising advantage of a very fast synthesis, even faster than a regular stevensite synthesis without the organic material being present.

However, it is is also possible to add the organic material at some moment during the synthesis, for example after the start, but before about 75% of the synthesis time has passed. Finally it is to be noted that for organoclay stevensite preparation, it is also possible to include the organic material in the stevensite after the clay has been synthesized, using ion exchange techniques.

Specific Applications of the Organoclay Materials

As indicated above, organoclay materials have various applications in industry, more in particular the materials can be added to a wide variety of polymer, plastic and resin matrices to form inventive nanocomposite materials of enhanced structural strength. They can also be used as rheological additives, as flame retardant additive, or in water purification applications.

The organo-stevensite clay materials of the present invention have the advantageous property of being extremely homogeneous and easy to produce in a reliable manner, thereby leading to much more homogeneous end product or use. Further, the properties of the material are such that they are more easily dispersible, for example in polymers, possibly due to their more optimal charge and charge distribution, hydrophobic properties, exfoliation properties and more optimal size and stacking.

Suitable polymers in which the clay materials of the present invention are used, are selected from polyolefines, such as PP and PE, nylon, styrene polymers, polycondensation polymers such as polyesters an polyamides (nylons) and vinylchloride polymers.

More specifically it is to be noted that the organo-stevensite clay materials of the present invention have distinct advantages in various applications, such as in improving thermal stability of polymers, such as polyethylenes, more in particular LDPE. Further advantages are the improvement of the water barrier properties of various nylons.

The organo-stevensite clay materials of the present invention may further be used to fixate cationic dyes and pigments in polymeric compositions.

In another embodiment the materials may be used to produce controlled porosity in specific materials. This may be accomplished by dispersing the organo-stevensite clay in the material followed by (thermal) treatment to remove the organic material in the clay, resulting in controlled porosity.

In the use as additive for plastics, the organoclay material can be added directly to the equipment in which the plastics is processed, such as an extruder. However, it is also possible to process the material first to a masterbatch, which masterbatch is subsequently added to the plastics processing equipment.

Ideally, during processing, the individual platelets will disperse uniformly into the polymer (exfoliation) giving the desired beneficial properties (increasing tensile strength, flexural modulus and heat distortion temperature while maintaining impact strength).

### DETAILED EMBODIMENTS

### Example

Water was added to 800 grams of water glass solution (27 wt. % SiO₂) up to a volume of 2.5 litre. 300 grams of both Zn(NO₃)₂*6H₂O and urea were added (Volume 3.3 litres) and the pH was adjusted with concentrated nitric acid to a value of around 1.5. The solution was added to a stirred stainless steel reactor, equipped with baffles and heated to 65-70° C. A hot solution of acidified dimethyloctadecylamine (ACROS, 87% 90 grams in 1 litre), 25 ml of concentrated nitric acid was used to obtain a more or less clear solution) was poured into the solution. The mixture was heated to 90° C. and stirred for 16-20 h at 500 rpm. After washing and drying a white fine powder was obtained, hydrophobic of nature. Yield 230-250 g.

Table 1 lists results calculated from the elemental analyses of two labscale products having different amounts of octadecylamine. Several conclusions can be drawn from these data: The Zn/Si ratio decreased due to the absence of Zn²⁺ in the interlayer for charge compensation. The C/N ratio found is around 19-20, related to the dimethyloctadecylammonium molecules (C₁₈C₂N) in the interlayer and on the platelet surface. All the Si initially present was recovered in the yield, whereas around 20% of the Zn²⁺ had not reacted. However, this Zn²⁺ can be correlated to the C₁₈C₂N now present for charge compensation. Absence of every Zn²⁺ requires two molecules of C₁₈C₂N; consequently, an N⁺ /ΔZn²⁺ ratio of two should be expected (See table, note 1). This is indeed the case, moreover, “recalculating” the Zn/Si ratio towards a Stevensite with interlayer Zn²⁺ resulted in values close to the theoretical value of 0.75. Thus, we synthesised a pure phase of organostevensite and the calculated Zn/Si ratio reflects the true layer ratio, lowered by presence of vacancies. SEM and TEM showing only one crystalline phase, confirmed this.

TABLE 1
Results (calculated) from elemental analysis.

| | | Reacted | Reacted | | | “Real” | CEC ⁽³⁾ |
|---|---|---|---|---|---|---|---|
| | Zn/Si | Si (%) | Zn (%) | C/N | N⁺/ΔZn^{2+ (1)} | Zn/Si ⁽²⁾ | (MEQ/100 g) |
| C₁₈C₂N | 0.64 | 99 | 84 | 19.4 | 1.8 | 0.74 | 51 |
| (90) ⁽⁴⁾ | | | | | | | |
| C₁₈C₂N | 0.57 | 104 | 79 | 19.1 | 2.1 | 0.72 | 32 |
| (150) ⁽⁴⁾ | | | | | | | |

⁽¹⁾ ΔZn²⁺ is defined as the initial molar amount (at Zn/Si = 0.75) minus the molar amount Zn²⁺ in the isolated dried material.
⁽²⁾ Molar amount calculated from elemental analysis: (Zn + 2* N)/Si.
⁽³⁾ Calculated via ΔZn²⁺ and the definition of CEC: (elemental mass of Zn (g)/valence Zn²⁺)/1000 per 100 gram of clay material.
⁽⁴⁾ 90 and 150 represent the used amount of C18C2N in grams.

The amount of C₁₈C₂N also influences the Zn/Si ratio. The more C₁₈C₂N present, the more vacancies are created. Finally, the calculated Cation Exchange Capacity (CEC) is around 30-50, considerably lower than values for montmorillonite (typically 80-120 meq/100 gram clay). The synthesis procedure can also be applied using Mg²⁺ instead of Zn²⁺, although longer synthesis time is required.

TEM and SEM results show a platelet morphology with increased interlayer space. Sizes vary from 40-100 nm, stacking is low. Dark field TEM confirms the high degree of crystallinity.

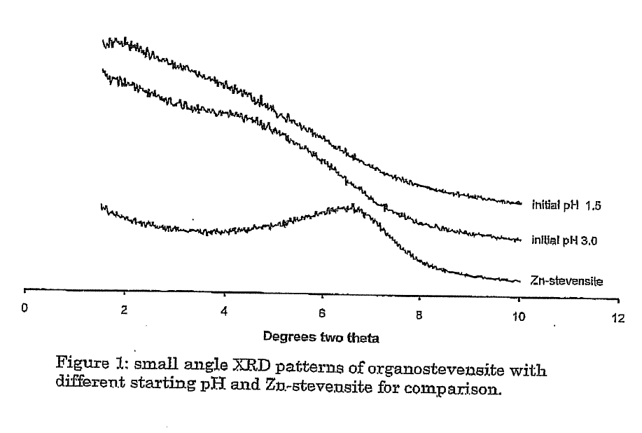

Interestingly, the XRD patterns from FIG. 1 show broad 001 reflections, with low intensity as compared to commercial nanoclays like Somasif™ and Cloisite™, indicating that ordering in the c-plane (indicative for “thickness” or stacking number) is much lower in organostevensite, which could be favourable to achieve exfoliation in the final nanocomposite. The presence of C₁₈C₂N in the interlayer instead of Zn²⁺ resulted in a shift of the 001 reflection from 14 Å to 46 Å (broad peak at around 2 degree two theta). The effect of initial pH is also shown: at pH 3, a broad shoulder at 17-20 Å is present, indicative of a different intercalation. Likely, the presence of different stacked platelets contributes to a broader PSD, resulting in poor filtration properties. The BET surface areas are typically between 40-80 m²/g, with pores of 4 nm present. The higher the initial concentrations in the synthesis mixture, the more agglomeration is observed, resulting in an increase in the number of larger pores.

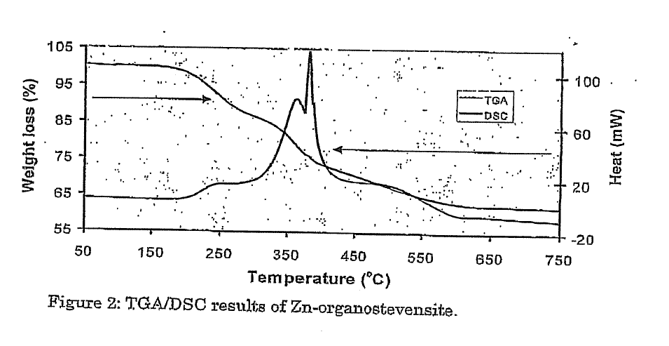

The results of the TGA/DSC measurements are depicted in FIG. 2. About 30 wt. % is lost when heating up 800° C., which can be ascribed to decomposing interlayer C₁₈C₂N molecules.

The first weight loss and corresponding heat release between 200-280° C. can be attributed to adsorbed, weakly bonded C₁₈C₂N possibly situated on the basal surfaces of the crystallites. At more elevated/higher temperatures, strongly bonded species start to decompose. The two peaks with maxima in DSC at 365 and 380° C. are not always present as two separate peaks (results not shown), they correspond with stronger bonded alkylammonium species.

1. Synthetic cationic organo-stevensite clay material.

2. Organoclay material according to claim 1, comprising an elementary swelling clay-structure of three repeating layers, with centrally in this elementary three-layer structure a layer of substantially divalent metal cations, octahedrally surrounded by oxygen and/or hydroxyl ions, and on both sides of said octahedrally surrounded layer, layers of tetrahedrally surrounded tetravalent cations, wherein at least part of the cation sites in the octahedrally surrounded layer have not been occupied, thereby creating vacancies, and wherein the said elementary three-layer structure further contains one or more organic cations.

3. Organoclay material according to claim 1, wherein the organic compound is selected from protonated alkyl- aryl-, aralkyl- and alkarylamines (primary and secondary), alkyl-aryl-, aralkyl- and alkaryl-phosphonium compounds and alkyl-aryl-, aralkyl- and alkaryl-sulphonium compounds, more in particular C₈-C₁₈ n-alkylamine.

4. Zn- or Mg-stevensite containing an organic cation, preferably an alkylamine.

5. Nanocomposite material comprising a matrix material having dispersed therein a synthetic organo-stevensite clay material according to claim 1.

6. Material according to claim 5, wherein the said matrix material is selected from nylon, polyolefines, such as polypropylene and polyethylene, polycondensation polymers such as polyesters and polyamides, styrene polymers and vinylchloride polymers.

7. Process for producing a synthetic cationic organoclay material according to claim 1, said process comprising providing an aqueous liquid containing inorganic ions of the clay structure, or precursors therefore, if necessary adapting the pH of the liquid and heating the liquid at a temperature and for a period sufficient to generate the clay structure, said process further comprising adding organic cationic material to the aqueous liquid at the beginning or during the production process for the organoclay material.

8. Process according to claim 7, wherein the initial pH of the solution is between 0.5 and 2.5.

9. Process according to claim 7, wherein the cationic organic material is present in the aqueous liquid containing inorganic ions of the clay structure, or precursors therefor.

10. Process according to claim 7, wherein the cationic organic material is added after the start of the synthesis, preferably before 75% of the synthesis time has passed.
